(19) United States
(12) Patent Application Publication
(10) Pub. No.: US 2025/0274702 A1
(43) Pub. Date: Aug. 28, 2025

(54) ELECTRONIC DEVICE AND METHOD FOR CONTROLLING ELECTRONIC DEVICE

(71) Applicant: SAMSUNG ELECTRONICS CO., LTD., Suwon-si (KR)

(72) Inventors: Donghyun JUNG, Suwon-si (KR); Jongbae KIM, Suwon-si (KR); Byoungsoo JE, Suwon-si (KR); Seungwan CHO, Suwon-si (KR)

(73) Assignee: SAMSUNG ELECTRONICS CO., LTD., Suwon-si (KR)

(21) Appl. No.: 19/209,017

(22) Filed: May 15, 2025

Related U.S. Application Data
(63) Continuation of application No. PCT/KR2023/018015, filed on Nov. 9, 2023.

(30) Foreign Application Priority Data
Dec. 5, 2022 (KR) 10-2022-0168070

(51) Int. Cl. H04R 1/34; H04S 7/00

(52) U.S. Cl. CPC H04R 1/345; H04S 7/302; H04R 2499/15

(57) ABSTRACT

An electronic device and a method for controlling the electric device including a projection unit, a memory, at least one first speaker that outputs a first sound signal along a direction opposite to a projection surface, at least one second speaker that outputs a second sound signal corresponding to a sound wave along at least one direction such that the sound wave is reflected on the ceiling or a wall of a space in which the electronic device is placed. The at least one processor, based on information that is included in the data about the content and directionality indicated in association with sound signals included in the content, and controls the at least one first speaker to output the first sound signal and controls the at least one second speaker to output the second sound signal while the image is displayed on the projection surface.

### CROSS-REFERENCE TO RELATED APPLICATION

This application is a continuation application is a continuation application, under 35 U.S.C. § 111 (a), of international application No. PCT/KR2023/018015, filed Nov. 9, 2023, which claims priority under 35 U. S. C. § 119 to Korean Patent Application No. 10-2022-0168070, filed Dec. 5, 2022, the disclosures of which are incorporated herein by reference in their entireties.

### TECHNICAL FIELD

The disclosure relates to an electronic device and a method for controlling the electronic device and more particularly, to an electronic device which may match a projection screen to a sound image and a method for controlling the electronic device.

### BACKGROUND ART

Recently, various types of projectors are being developed according to a trend of increase of outdoor activities and a trend of diversity of devices of a user. In particular, a projector disposed on a ceiling or a table or using a method by which a speaker was separately connected was generally used in the past but recently, an ultra-short focus projector of which a freedom degree of installation is high receives attention and also, a demand for a projector where a speaker is built in itself such that there is no need to connect a separate speaker.

However, the ultra-short focus projector has a problem that a sound image between a projection screen and sound corresponding thereto is not matched because the projector is disposed at the lower end of the projection screen. With respect to the above, a conventional technology has tried to match the projection screen to the sound image by using a speaker having a plurality of channels but it does not overcome a limit that the sound image is positioned at the lower end of the projection screen, particularly, this limit emerges as a size of the projection screen becomes large.

Also, the conventional technology faces a limit that it is difficult to output sound of a lower frequency sound range with a built-in speaker because an optical system of a projector vulnerable to vibration exists and a limit that it is more difficult to achieve sound image localization because a width of an up, down, left, or right side of a projector is limited as a size of the projector is minimized.

### DISCLOSURE

### Technical Solution

The disclosure is to overcome the limits of the conventional technology as above, wherein an aspect of the disclosure is to provide an electronic device capable of matching a screen projected by a projection portion to a sound image by using a plurality of speakers and a method for controlling the same.

According to an embodiment of the disclosure for achieving an aspect as above, an electronic device includes a projection portion, a memory, at least one first speaker to output a first sound signal along a direction opposite a projection surface on which light emitted by the projection portion is projected, at least one second speaker to output a second sound signal corresponding to a sound wave along at least one direction such that the sound wave is reflected from a ceiling or a wall of a space where the electronic device is disposed, and at least one processor configured to control the projection portion to output an image included in a content based on data about the content, identify whether the first sound signal is to be outputted through the at least one first speaker and the second sound signal is to be outputted through the at least one second speaker among sound signals based on information included in the data about the content and directionality indicated in association with the sound signals, and while the image is displayed on the projection surface, control the at least one first speaker to output the first sound signal and control the at least one second speaker to output the second sound signal.

Here, the at least one first speaker may be a lower end speaker implementing a sound image corresponding to a lower end area of the projection surface, and the at least one second speaker may include at least one of a center speaker implementing a sound image corresponding to a center area of the projection surface or an upper end speaker implementing a sound image corresponding to an upper end area of the projection surface.

Here, the electronic device may further include a plurality of third speakers including a left speaker implementing a sound image corresponding to a left area of the projection surface and a right speaker implementing a sound image corresponding to a right area of the projection surface.

Here, at least one of the at least one first speaker or the at least one second speaker may include a plurality of holes or a waveguide structure for adjusting a direction of a sound wave corresponding to a sound signal.

Meanwhile, the at least one first speaker may include at least one of a plurality of speaker units disposed in a mutual symmetric structure for offsetting vibration incurred from the sound signal outputted by the at least one first speaker and an interrupter for preventing sound outputted by the at least one first speaker from being transmitted to the projection portion.

Meanwhile, the electronic device may further include a driving portion and a sensor, wherein the at least one processor may obtain information about a distance between the projection portion and the projection surface through the sensor, and control the driving portion to change a position or an output direction of at least one of the at least one first speaker or the at least one second speaker based on the information about the distance.

Here, the at least one processor may adjust a parameter related to at least one sound image of the first sound signal or the second sound signal based on the information about the distance, and control the at least one first speaker to output the first sound signal and control the at least one second speaker to output the second sound signal based on the adjusted parameter.

According to an embodiment of the disclosure for achieving the aspect as above, a method of controlling an electronic device includes controlling a projection portion included in the electronic device to output an image included in a content based on data about the content, identifying a first sound signal to be outputted through at least one first speaker included in the electronic device and a second sound signal to be outputted through at least one second speaker included in the electronic device among sound signals based on information included in the data about the content and directionality indicated in association with the sound signals included in the content, and while the image is displayed on a projection surface, controlling the at least one first speaker to output the first sound signal and controlling the at least one second speaker to output the second sound signal, wherein the at least one first speaker outputs the first sound signal along a direction opposite the projection surface on which light emitted by the projection portion is projected, and wherein the at least one second speaker outputs the second sound signal corresponding to a sound wave in at least one direction such that the sound wave is reflected from a ceiling or a wall of a space where the electronic device is disposed.

Here, the at least one first speaker may be a lower end speaker implementing a sound image corresponding to a lower end area of the projection surface, and the at least one second speaker may include at least one of a center speaker implementing a sound image corresponding to a center area of the projection surface or an upper end speaker implementing a sound image corresponding to an upper end area of the projection surface.

Here, the electronic device may further include a plurality of third speakers including a left speaker implementing a sound image corresponding to a left area of the projection surface and a right speaker implementing a sound image corresponding to a right area of the projection surface.

Here, at least one of the at least one first speaker or the at least one second speaker may include a plurality of holes or a waveguide structure for adjusting a direction of a sound wave corresponding to a sound signal.

Meanwhile, the at least one first speaker may include at least one of a plurality of speaker units disposed in a mutual symmetric structure for offsetting vibration incurred from the sound signal outputted by the at least one first speaker and an interrupter for preventing sound outputted by the at least one first speaker from being transmitted to the projection portion.

Meanwhile, the method of controlling the electronic device may further include obtaining information about a distance between the projection portion and the projection surface, and controlling the driving portion included in the electronic device to change a position or an output direction of at least one of the at least one first speaker or the at least one second speaker based on the information about the distance.

Meanwhile, the method of controlling the electronic device may further include adjusting a parameter related to at least one sound image of the first sound signal or the second sound signal based on the information about the distance, and controlling the at least one first speaker to output the first sound signal and controlling the at least one second speaker to output the second sound signal based on the adjusted parameter.

An embodiment of the disclosure for achieving the aspect as above relates to a non-transitory computer readable recording medium including a program executing a method of controlling an electronic device, wherein the method of controlling the electronic device includes controlling a projection portion included in the electronic device to output an image included in a content based on data about the content, identifying whether at least one the first sound signal is to be outputted through the at least one first speaker included in the electronic device and the second sound signal is to be outputted through the at least one second speaker included in the electronic device among sound signals based on information included in data about the content and directionality indicated in association with the sound signals, and while the image is displayed on a projection surface, controlling the at least one first speaker to output the first sound signal and controlling the at least one second speaker to output the second sound signal, wherein the at least one first speaker outputs a sound signal in a direction toward an opposite of the projection surface on which light emitted by the projection portion is projected, and wherein the at least one second speaker outputs a sound signal corresponding to a sound wave in at least one direction such that the sound wave is reflected from a ceiling or a wall of a space where the electronic device is disposed.

### DESCRIPTION OF DRAWINGS

FIG. 1 is a block diagram briefly illustrating a configuration of an electronic device according to an embodiment;

FIG. 2 is a view illustrating an output direction of a sound signal by a lower end speaker according to an embodiment;

FIGS. 3 and 4 are views illustrating an output direction of a sound signal by an upper end speaker according to an embodiment;

FIG. 5 is a view illustrating an output direction of a sound signal by a center speaker according to an embodiment;

FIG. 6 is a view illustrating a combination process of sound signals according to an embodiment;

FIG. 7 is a block diagram specifically illustrating a configuration of an electronic device according to an embodiment;

FIGS. 8 and 9 are views illustrating an output direction of a left speaker and a right speaker according to an embodiment; and

FIG. 10 is a flow chart illustrating a method of controlling an electronic device according to an embodiment.

### MODE FOR INVENTION

Embodiments of the disclosure may be modified in various different forms and may have various embodiments, wherein specific embodiments are exemplified in the drawings and specifically explained in the detailed description. However, it should be noted that the various embodiments are not for limiting the scope of the disclosure to a specific embodiment but they should be interpreted to include all modifications, equivalents, and/or alternatives of the embodiments of the disclosure. With respect to the description of the drawings, similar components may be designated by similar reference numerals.

In case it is determined that in describing the disclosure, the detailed description of related known functions or configurations may unnecessarily confuse the gist of the disclosure, the detailed description thereof will be omitted.

In addition, the embodiments below may be modified in various different forms, and the scope of the technical idea of the disclosure is not limited to the embodiments below. Rather, these embodiments are provided to make the disclosure more sufficient and complete, and to fully convey the technical idea of the disclosure to those skilled in the art.

The terms used in the disclosure are used only to explain specific embodiments and are not intended to limit the scope of a right of the disclosure. A singular expression includes a plural expression, unless obviously differently defined in the context.

In the disclosure, the expression such as “have,” “may have,” “include”, or “may include” denotes the existence of such a characteristic (e.g. a numerical value, a function, an operation, or a component such as a part), and the expression does not exclude the existence of an additional characteristic.

In the disclosure, the expression “A or B”, “at least one of A and/or B”, “one or more of A and/or B”, or the like may include all possible combinations of the listed items. For example, “A or B”, “at least one of A and B”, or “at least one of A or B” may refer to all of the following cases: (1) including at least one A, (2) including at least one B, or (3) including all of at least one A and at least one B.

The expression “1st”, “2nd”, “first”, “second”, or the like used in the disclosure may be used to describe various elements regardless of any order and/or degree of importance, wherein the expression is used only to distinguish one element from another element and is not intended to limit the elements.

Meanwhile, the description that one element (e.g. a first element) is “(operatively or communicatively) coupled with/to” or “connected to” another element (e.g. a second element) should be interpreted such that the one element is directly coupled to the another element or the one element is coupled to the another element through the other element (e.g. a third element).

In contrast, the description that one element (e.g. a first element) is “directly coupled” or “directly connected” to another element (e.g. a second element) may be interpreted to mean that the other element (e.g. a third element) is not present between the one element and the another element.

The expression “configured to” used in the disclosure may be interchangeably used with other expressions, for example, “suitable for”, “having the capacity to”, “designed to”, “adapted to”, “made to”, or “capable of” depending on circumstances. The term “configured to (or set to)” may not necessarily mean that a device is “specifically designed to” do in terms of hardware.

Instead, under some circumstances, the expression “a device configured to” may mean that the device “is capable of” performing an operation together with another device or component. For example, the phrase “a processor configured to (set to) perform A, B, and C” may mean a dedicated processor for performing the corresponding operations (e.g. an embedded processor), or a generic-purpose processor that may perform the corresponding operations by executing one or more software programs stored in a memory device (e.g. a CPU or an application processor).

In embodiments of the disclosure, a ‘module’ or ‘part’ may perform at least one function or operation and may be implemented as hardware or software, or as a combination of hardware and software. Also, a plurality of ‘modules’ or ‘parts’ may be integrated into at least one module and implemented as at least one processor, excluding a ‘module’ or ‘part’ that needs to be implemented as specific hardware.

Meanwhile, various elements and areas in the drawings are illustrated schematically. Accordingly, the technical idea of the disclosure is not limited by the relative sizes or intervals illustrated in the appended drawings.

Hereinafter, with reference to the appended drawings, an embodiment according to the disclosure is specifically described to be easily embodied by those skilled in the art.

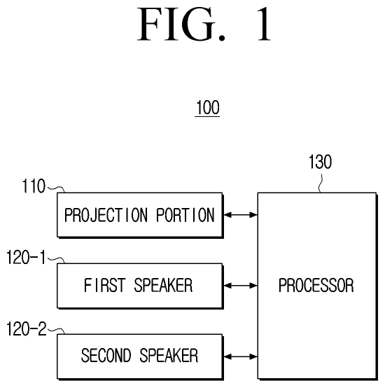

FIG. 1 is a block diagram briefly illustrating a configuration of an electronic device 100 according to an embodiment.

As shown in FIG. 1, the electronic device 100 according to an embodiment of the disclosure may include a projection portion 110, a first speaker 120-1, a second speaker 120-2, and a processor 130.

The electronic device 100 according to the disclosure refers to a device including a plurality of speakers 120 together with the projection portion 110. That is, the electronic device 100 is a device including the plurality of speakers 120 capable of outputting sound together with the projection portion 110 capable of projecting an image, wherein there is not any particular limitation in a type of electronic device 100.

The projection portion 110 may project an image onto a projection surface. Specifically, the projection portion 110 may include a light source such as a light emitting diode (LED) and may display the image onto the projection surface by emitting light corresponding to the image based on image data or data about a content including the image.

The projection portion 110 may be a component which needs a focus distance of a preset distance or more. Specifically, a projection distance of a preset distance or more may be needed between the projection portion 110 and the projection surface, wherein a size of the image projected onto the projection surface may be determined according to the projection distance. For example, the electronic device 100 may be implemented as a projector which may display a projection screen close to 100 inches if the distance between the projection portion 110 and the projection surface is merely 20 cm to 1 m.

The plurality of speakers 120 may output a sound signal based on data about a content including audio data or audio sound. In particular, the plurality of speakers 120 according to the disclosure may be a directional speaker for outputting a sound signal in a specific direction. For example, the plurality of speakers 120 may include a plurality of holes or a waveguide structure for adjusting a direction of a sound wave corresponding to a sound signal. Further, the plurality of holes may be implemented in a mesh form of a plane surface or a curved surface, and the waveguide structure may have a straight cylindrical shape, a bent cylindrical shape, or a horn shape in which an area is widen from the inside to the outside. A structure for implementing directionality of the plurality of speakers 120 according to the disclosure does not comply with a particular limitation.

As shown in FIG. 1, the plurality of speakers 120 according to the disclosure may include the first speaker 120-1 and the second speaker 120-2. Further, each of the first speaker 120-1 and the second speaker 120-2 may be implemented in one or a plural number.

According to the disclosure, the ‘first speaker 120-1’ is used as the term for collectively referring to speakers capable of outputting a sound signal in a direction toward an opposite of the projection surface on which light emitted by the projection portion 110 is projected. Specifically, if a sound signal is outputted by the first speaker 120-1, a sound wave corresponding to a sound signal may be directly transmitted to a space where a user is positioned for watching a content displayed on the projection surface. For example, the first speaker 120-1 may be a ‘lower end speaker’ implementing a sound image corresponding to a lower end area of the projection surface.

The second speaker 120-2 may collectively refer to speakers which may output a sound signal corresponding to a sound wave in a direction such that a sound wave is reflected from a ceiling or a wall of a space where the electronic device 100 is disposed. Specifically, if a sound signal is outputted by the second speaker 120-2, the sound wave corresponding to the sound signal may be transmitted to a space where the user is positioned after the sound wave is reflected one or more times from the ceiling and/or the wall of the space where the electronic device 100 is disposed. Here, the user may recognize that the sound signal is outputted from the ceiling or the wall reflecting directly before the sound signal is transmitted to the space where the user is positioned. For example, the second speaker 120-2 may include at least one of a ‘center speaker’ implementing a sound image corresponding to a center area of the projection surface or a ‘upper end speaker’ implementing a sound image corresponding to an upper end area of the projection surface.

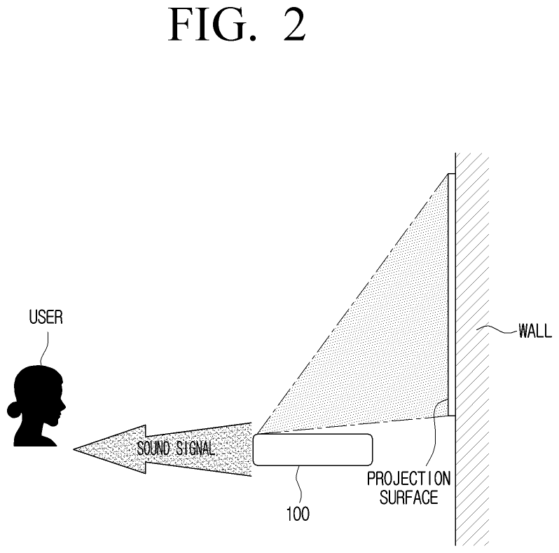

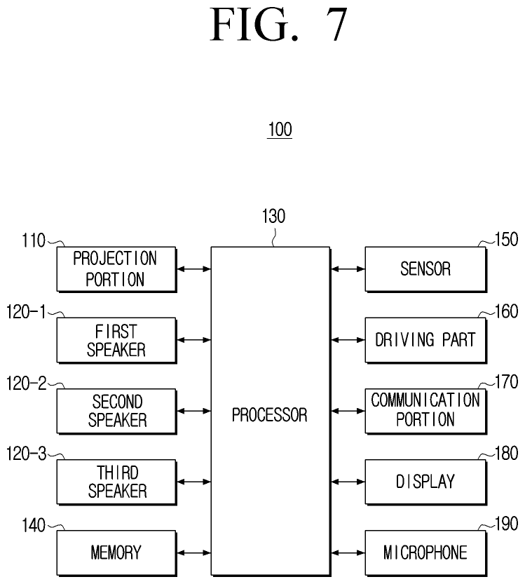

As above, the plurality of speakers 120 according to the disclosure are defined by dividing the speakers into the first speaker 120-1 which may be implemented as the lower end speaker and the second speaker 120-2 which may include the center speaker and the upper end speaker, wherein a specific operation including an output direction of the sound signal according to a type of each speaker is described with reference to FIGS. 2 to 6. Meanwhile, the plurality of speakers 120 according to the disclosure may include a third speaker 120-3 which may include a left speaker and a right speaker besides the first speaker 120-1 and the second speaker 120-2, wherein the third speaker 120-3 is described with reference to FIGS. 7 to 9.

Meanwhile, at least one speaker among the plurality of speakers 120 may include at least one of a plurality of speakers 120 units disposed in a mutual symmetric structure for offsetting vibration incurred from an output sound signal and an interrupter for preventing output sound from being transmitted to the projection portion 110.

In particular, if vibration incurred by the plurality of speakers 120 is transmitted to the projection portion 110 including an optical system, distortion of the optical system may occur, and thus speaker units and passive radiators included in the plurality of speakers 120 may have a symmetrically disposed structure. Accordingly, if the plurality of speakers 120 outputs a sound signal, incurred vibration may be offset, and thus playback of a lower frequency sound is possible without screen trembling.

Also, the interrupter may be implemented as a form of a waveguide and may suppress an air flow which may be introduced into a speaker and output a sound signal to the outside of the electronic device 100. Accordingly, the plurality of speakers 120 may minimize an effect of vibration with respect to the optical system included in the projection portion 110.

The processor 130 controls operations of the electronic device 100 overall. Specifically, the processor 130 may be connected to a configuration of the electronic device 100 including the projection portion 110 and the plurality of speakers 120 to control operations of the electronic device 100 overall. Also, the processor 130 may be implemented as one or more processors 130.

The processor 130 may be implemented in various methods. For example, the processor 130 may be implemented as at least one of an Application Specific Integrated Circuit (ASIC), an embedded processor, a micro 190 processor, a hardware control logic, a hardware Finite State Machine (FSM), or a Digital Signal Processor (DSP). Meanwhile, in the disclosure, the term “processor 130” may be used as a meaning including a Central Processing Unit (CPU), a Graphic Processing Unit (GPU), a Micro Processor Unit (MPU), etc.

In particular, according to various embodiments according to the disclosure, the processor 130 may control the projection portion 110 to output an image included in a content based on data about the content. Here, the data about the content may be data stored in memory 140 or data received from an external device. Also, the operation of outputting the image included in the content may be performed based on a user command for watching the content.

The processor 130 may identify a first sound signal to be outputted through the at least one first speaker 120-1 and a second sound signal to be outputted through the at least one second speaker 120-2 among sound signals based on information included in the data about the content and indicating directionality of the sound signals included in the content.

Here, the ‘information indicating directionality of sound signals’ means information indicating that it is preferable that the sound signals included in the data about the content be outputted in a left, a right, a center, an upper end direction, or the like. For example, the information indicating directionality of sound signals may be information indicating that each sound signal corresponds to a center, left, right, surround, or height component or channel.

In an example, the processor 130 may identify sound signals indicating a left, right, and center direction as sound signals to be outputted through the lower end speaker, identify sound signals indicating an upper end direction as a sound signal to be outputted through the upper end speaker, identify sound signals indicating a left direction as a sound signal to be outputted through a left speaker, identify sound signals indicating a right direction as sound signals to be outputted through the right speaker, and identify sound signals indicating a left, a right, an upper end, and a center direction as sound signals to be outputted through the center speaker.

As above, if the first sound signal and the second sound signal are identified, the processor 130 may control at least one first speaker 120-1 to output the first sound signal and control at least one second speaker 120-2 to output the second sound signal while the image is displayed on the projection surface. Again, the processor 130 may implement a sound image corresponding to the lower end area of the projection surface by outputting the first sound signal through the first speaker 120-1 and implement a sound image corresponding to a center area or an upper end area of the projection surface by outputting the second sound signal through the second speaker 120-2.

According to the embodiment as above, because the electronic device 100 according to the disclosure is disposed at the lower end of the projection screen, it may adjust the sound image which may be positioned at the lower end of the projection screen to be matched to the projection screen by using the plurality of speakers 120 to implement an immersive sound system. In particular, the electronic device 100 may raise the sound image to correspond to the projection screen by using the speakers having directionality to resolve a sense of difference of the user due to a mismatch between the projection screen and the sound image.

Also, the electronic device 100 may minimize an effect of vibration with respect to the optical system included in the projection portion 110 by the plurality of speaker 120 units disposed in the mutual symmetric structure and the interrupter to prevent output sound from being transmitted to the projection portion 110.

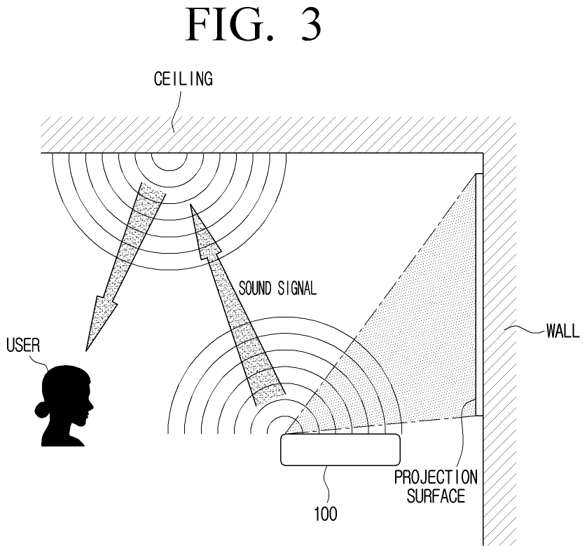

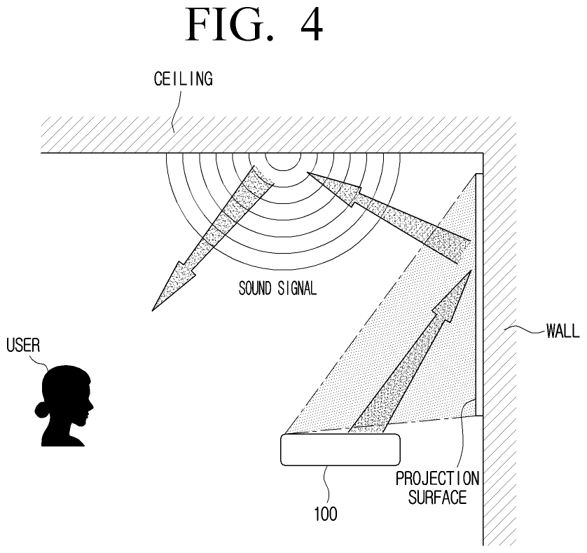

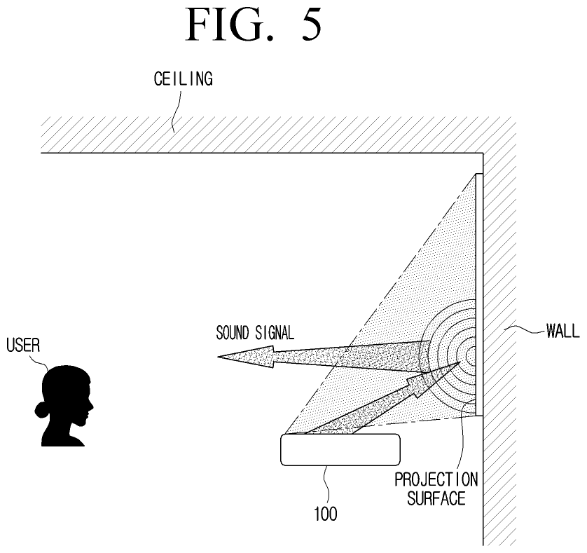

FIG. 2 is a view illustrating an output direction of a sound signal by a lower end speaker according to an embodiment, FIGS. 3 and 4 are views illustrating an output direction of a sound signal by an upper end speaker according to an embodiment, and FIG. 5 is a view illustrating an output direction of a sound signal by a center speaker according to an embodiment.

As shown in FIG. 2, the first speaker 120-1 may include the lower end speaker implementing a sound image corresponding to a lower end area of a projection surface. In particular, the lower end speaker is a speaker outputting a sound signal toward a space where a user is positioned, wherein it may be implemented as a multi-way speaker in which the plurality of speaker 120 units divide and emit sound signals of different frequency bands for high sound quality. For example, the lower end speaker may output a sound signal corresponding to a center, left, or right component or channel.

As shown in FIGS. 3 and 4, the second speaker 120-2 may include the ‘upper end speaker’ implementing a sound image corresponding to an upper end area of a projection surface. In particular, the projection portion 110 according to the disclosure may include an ultra-short focus lens and in this case, the electronic device 100 is disposed at the lower end of the projection surface. Also, to implement a screen larger than a general TV, the electronic device 100 needs to be farther from the projection surface, wherein it is preferable that that electronic device 100 be positioned to be more close to the lower end of the projection surface to implement a large screen while maintaining a short projection distance. However, as the electronic device 100 is positioned to be more close to the lower end of the projection surface, an error between the projection surface and the sound image becomes large and thus, the user may feel a sense of difference.

Therefore, the second speaker 120-2 according to the disclosure may output sound signals in an output direction capable of implementing a sound image corresponding to the center area or the upper end area of the projection surface at the lower end of the projection surface to raise the sound image. For example, the upper end speaker may output a sound signal corresponding to a height or surround component or channel.

Here, the upper end area may include an area positioned at an upper side than the center area of the projection surface and a ceiling area of a space where the electronic device 100 is disposed. That is, the upper end speaker according to the disclosure may include a so-called ‘top speaker’ and ‘ceiling speaker’.

As an example of FIG. 3, the upper end speaker may output sound signals in a direction such that a sound wave corresponding to the sound signals may be reflected from a ceiling and then, reach the user. Moreover, as shown in an example of FIG. 4, the upper end speaker may output sound signals in a direction such that a sound wave corresponding to the sound signals may be reflected from a wall where the projection surface is formed and be reflected again from the ceiling and then, reach the user.

Meanwhile, which speaker the upper end speaker according to the disclosure is implemented as among the top speaker or the ceiling speaker may be determined depending on whether a position of the sound image according to the upper end speaker corresponds to the upper end area of the projection surface or corresponds to the ceiling area of the upper side of the projection surface.

As shown in FIG. 5, the second speaker 120-2 may include the center speaker implementing a sound image corresponding to a center area of a projection surface. Specifically, the center speaker may output sound signals in a direction such that a sound wave corresponding to the sound signals may be reflected from a wall where the projection surface is formed and then, reach the user.

In the center speaker, it is preferable that the sound image be accurately positioned at the center area of the projection surface because sound such as a voice of a person included in a content may cause a sense of difference if the content displayed on the projection surface does not match the sound image. Therefore, the center speaker may be implemented as a speaker having strong directionality. For example, the center speaker may output a sound signal corresponding to a center, left, right, or height component or channel.

As aforementioned, the electronic device 100 may adjust the sound image which may be positioned at the lower end of the projection screen to be matched to the projection screen by using the lower end speaker, the upper end speaker including the top speaker and the ceiling speaker, and the center speaker. Meanwhile, the speakers as above are merely an example, wherein it is obvious that the electronic device 100 may include only part of the aforementioned speakers and may further include a speaker capable of implementing various sound images besides.

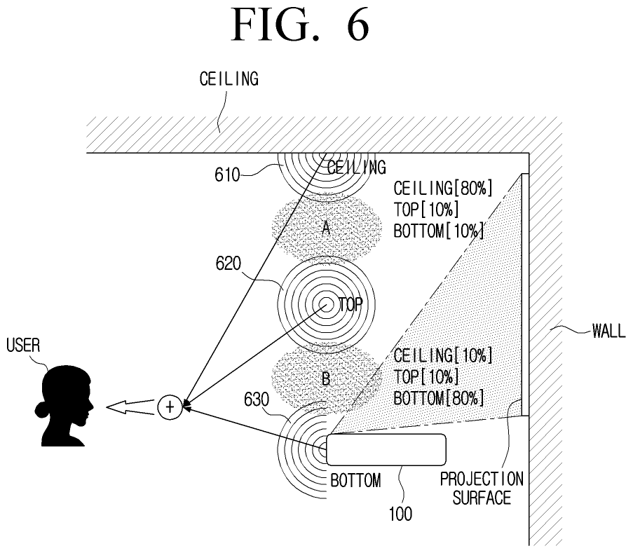

FIG. 6 is a view illustrating a combination process of sound signals according to an embodiment.

According to the disclosure, the electronic device 100 may implement sound images of the number exceeding the number of the plurality of speakers 120 by using the plurality of speakers 120. For example, the electronic device 100 may implement four or more sound images using three speakers.

According to an embodiment, the plurality of speakers 120 according to the disclosure may include the ceiling speaker implementing a sound image corresponding to the ceiling area 610, the top speaker implementing a sound image corresponding to the top area 620, and the lower end speaker implementing a sound image corresponding to the lower end area 630. In this case, the processor 130 may implement a sound image corresponding to another area by using the ceiling speaker, the top speaker, and the lower end speaker.

For example, the processor 130 may control the ceiling speaker to output sound signals in a volume of 80%, control the top speaker to output sound signals in a volume of 10%, and control the lower end speaker to output sound signals in a volume of 10% to implement a sound image corresponding to an area A of FIG. 6. Also, the processor 130 may control the ceiling speaker to output sound signals in a volume of 10%, control the top speaker to output sound signals in a volume of 10%, and control the lower end speaker to output sound signals in a volume of 80% to implement a sound image corresponding to an area B of FIG. 6.

Again, the electronic device 100 according to the disclosure may perform rendering with respect to sound signals to implement a sound image more matching the projection screen, and thus, may provide an immersive sound optimized to the projection screen. In particular, the electronic device 100, if a distance between the projection portion 110 and the projection surface is changed, may implement sound image localization under consideration of the changed distance, wherein it is after-mentioned with reference to FIG. 7.

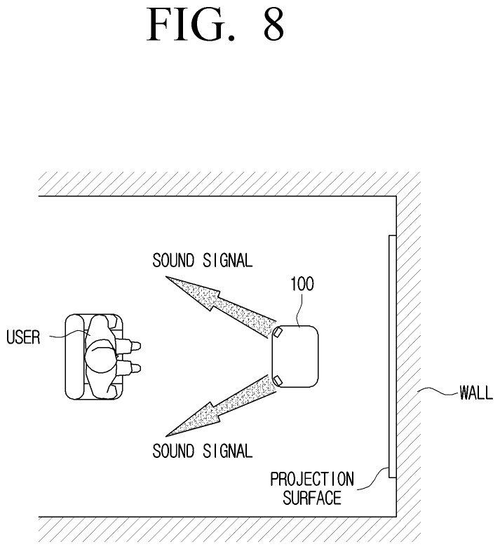

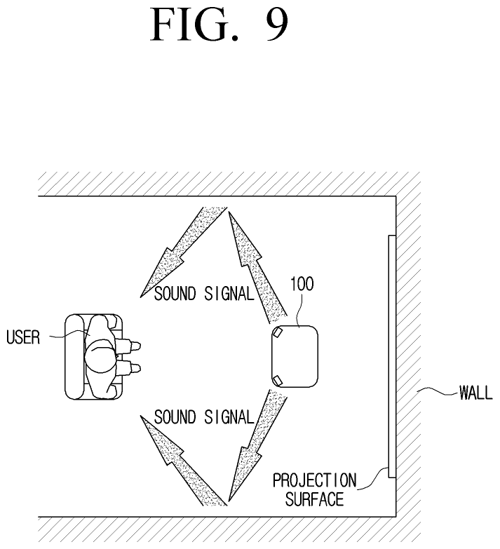

FIG. 7 is a block diagram specifically illustrating a configuration of an electronic device 100 according to an embodiment. Further, FIGS. 8 and 9 are views illustrating an output direction of a left speaker and a right speaker according to an embodiment.

As shown in FIG. 7, the plurality of speakers 120 according to the disclosure may further include a third speaker 120-3 besides the first speaker 120-1 and the second speaker 120-2. Also, the electronic device 100 may further include memory 140, a sensor 150, a driving portion 160, a communication portion 170, a display 180, and a microphone 190. However, the configurations shown in FIGS. 1 and 7 are merely exemplary, wherein it is obvious that a new configuration may be added to the configuration shown in FIGS. 2 and 3 or part of the configuration may be omitted upon implementing the disclosure.

The third speaker 120-3 may collectively refer to speakers which may output a sound signal in a left or right direction of the electronic device 100. Specifically, if a sound signal is outputted by the third speaker 120-3, the sound wave corresponding to the sound signal may be directly transmitted to a space where the user is positioned without a condition that the sound wave corresponding to the sound signal is reflected from the wall of the space where the electronic device 100 is disposed or is reflected from the ceiling of the space where the electronic device 100 is disposed. For example, the third speaker 120-3 may include a ‘left speaker’ implementing a sound image corresponding to a left area of the projection surface or a ‘right speaker’ implementing a sound image corresponding to a right area of the projection surface.

As shown in FIGS. 8 and 9, the third speaker 120-3 may include the ‘left speaker’ implementing a sound image corresponding to the left area of the projection surface and a right speaker implementing a sound image corresponding to the right area of the projection surface.

As shown in FIG. 8, each of the left speaker and the right speaker may output sound signals in a left and right direction of the electronic device 100 toward a space where a viewer is positioned. Also, as shown in FIG. 9, each of the left speaker and the right speaker may also output sound signals in a direction such that a sound wave corresponding to a sound signal may be reflected from a left wall and a right wall and then, reach the user. For example, the left speaker may output a sound signal corresponding to a left component or channel and the right speaker may output a sound signal corresponding to a right component or channel. Also, the left speaker and the right speaker may also output sound signals corresponding to a surround component or channel.

In particular, if the electronic device 100 has a form in which a left-to-right width is narrow such as a projector, there is a limit exhibiting a narrow stereo characteristic. Therefore, the electronic device 100 may output a sound signal through the left speaker and the right speaker and thus, may widen a sound stage and enhance a wide stereo effect accordingly.

Meanwhile, according to an embodiment, the processor may identify a position per object of the image corresponding to the content and match a position of the identified object to the sound image of the sound signal. For example, the processor may output a sound signal corresponding to a speech of a first person, which is an object displayed on the left of the projection surface through the left speaker and output a sound signal corresponding to a speech of a second person, which is an object displayed on the right of the projection surface through the right speaker. Also, the processor may input an image corresponding to a content to a neural network model to identify a type of object included in the image and may adjust a sound image of the sound signal based on the type of the identified object.

The memory 140 may store at least one instruction related to the electronic device 100. Further, the memory 140 may store an Operating System (O/S) for driving the electronic device 100. Also, the memory 140 may store various software programs or applications in order that the electronic device 100 operates according to various embodiments of the disclosure. Further, the memory 140 may include semiconductor memory such as flash memory or a magnetic storage medium such as a hard disk.

Specifically, the memory 140 may store various software modules for operating the electronic device 100 according to various embodiments of the disclosure, and the processor 130 may execute various software modules stored in the memory 140 to control an operation of the electronic device 100. That is, the memory 140 may be accessed by the processor 130, wherein the processor 130 may perform reading/recording/correcting/deleting/renewing, or the like data.

Meanwhile, the term “memory 140” in the disclosure may be used as a meaning including memory 140, ROM in the processor 130 (not shown), RAM (not shown), or a memory card mounted onto the electronic device 100 (not shown) (e.g. a micro SD card, a memory stick).

In particular, in various embodiments according to the disclosure, the memory 140 may store data about a content. Also, the memory 140 may store look-up table information indicating a position for each of the plurality of speakers 120 and/or an output direction for each of the plurality of speakers 120 suitable for a distance between the projection portion 110 and the projection surface.

Besides, the memory 140 may store various information required in a range for achieving the aspect of the disclosure, and the information stored in the memory 140 may be received from the external device or be renewed by input of the user.

The sensor 150 may sense a distance between the ceiling and wall of the space where the electronic device 100 is disposed and the projection portion 110. Specifically, the sensor 150 may be a time of flight (ToF) sensor which may emit infrared rays to obtain information about the distance between the ceiling and wall and the projection portion 110. Moreover, the sensor 150 may be the sensor 150 which may measure a distance such as a lidar sensor.

In particular, the processor 130 may obtain information about a distance between the projection 110 and the projection surface through the sensor 150. Further, the processor 130 may adjust a parameter related to at least one sound image of the first sound signal or the second sound signal based on information about the distance between the projection portion 110 and the projection surface. Further, the processor 130 may control at least one first speaker 120-1 to output the first sound signal and control at least one second speaker 120-2 to output the second sound signal based on the adjusted parameter.

For example, the memory 140 may store look-up table information indicating a position for each of the plurality of speakers 120 and/or an output direction for each of the plurality of speakers 120 suitable for the distance between the projection portion 110 and the projection surface, and thus the processor 130 may identify whether the position and the output direction of the plurality of speakers 120 is suitable for the distance between the projection portion 110 and the projection surface by using the look-up table information as above.

The processor 130, if identifying that the position and the output direction of the plurality of speakers 120 is not suitable for the distance between the projection portion 110 and the projection surface, may perform a combination process of the sound signal as aforementioned with reference to FIG. 6 for sound image localization with respect to the projection surface and besides, may adjust an effective frequency suitable for the distance between the projection portion 110 and the projection surface and a delay per channel.

For example, the processor 130 may adjust timing of sound signals outputted through the plurality of speakers 120 in consideration of a time consumed until light emitted through the projection portion 110 is projected to the projection surface and a time consumed until the sound signal outputted through the plurality of speakers 120 is reflected directly or from the ceiling or the wall and is transmitted to the user.

The driving portion 160 may adjust a position of the electronic device 100, a position of the plurality of speakers 120 or an output direction of the plurality of speakers 120. In particular, the driving portion 160 may include at least one motor with which the plurality of speakers 120 are combined, and the position of the plurality of speakers 120 or the output direction of the plurality of speakers 120 may be adjusted by control of the processor 130.

For example, the processor 130, if identifying that the position and the output direction of the plurality of speakers 120 are not suitable for the distance between the projection portion 110 and the projection surface, may control the driving portion 160 to change the position or the output direction of at least one of the first speaker 120-1 or the second speaker 120-2 in order that the position and the output direction of the plurality of speakers 120 are suitable for the distance between the projection portion 110 and the projection surface based on information about the distance between the projection portion 110 and the projection surface.

According to the aforementioned example, the electronic device 100, if a size of the projection screen of the projection portion 110 is changed, may perform sound image positioning per sound channel fitted to the size of the projection screen.

The communication portion 170 may include a circuit and perform communication with the external device. Specifically, the processor 130 may receive various data or information from the external device connected through the communication portion 170 and transmit various data or information to the external device.

The communication portion 170 may include at least one of a Wi-Fi module, a Bluetooth module, a wireless communication module, a NFC module, or an Ultra Wide Band (UWB) module. Specifically, the Wi-Fi module and the Bluetooth module may perform communication in a Wi-Fi method and a Bluetooth method, respectively. In case of using the Wi-Fi module or the Bluetooth module, the module may receive and transmit various connection information such as a SSID in advance, connect communication by using the connection information, and then receive and transmit various information.

Also, the wireless communication module may perform communication according to various communication standards such as IEEE, ZigBee, 3rd Generation (3G), 3rd Generation Partnership Project (3GPP), Long Term Evolution (LTE), and 5th Generation (5G). Further, the NFC module may perform communication in a Near Field Communication (NFC) method using a band of 13.56 MHz among various RF-ID frequency bands such as 135kHz, 13.56 MHz, 433 MHZ, 860˜960 MHz, 2.45 GHz, etc. Also, the UWB module may accurately measure Time of Arrival (ToA) which is a time when a pulse arrives at a target and Angle of Arrival (AoA) which is an angle of arrival of a pulse in a transmission device through communication between UWB antennas, and accordingly, it is possible to accurately recognize a distance and a position in an error range within tens of centimeters indoors.

In particular, in various examples according to the disclosure, the processor 130 may receive data about the content from the external device through the communication portion 170. Also, the processor 130 may receive a user command for playback of a content, a user command for changing an output direction of the projection portion 110, a user command for changing a position or an output direction of the plurality of speakers 120, or the like from the external device through the communication portion 170.

The display 180 may output image data by control of the processor 130. Specifically, the display 180 may output an image prestored in the memory 140 by control of the processor 130. The display 180 may be implemented as a Liquid Crystal Display Panel (LCD), an Organic Light Emitting Diode (OLED), or the like or the display 180 may be implemented as a flexible display, a transparent display, or the like depending on cases. Meanwhile, the display 180 according to the disclosure is not limited to a specific type.

In particular, in various examples according to the disclosure, the display 180 may display a user interface stored in the memory 140. Further, the processor 130 may receive a user command for playback of a content, a user command for changing an output direction of the projection portion 110, or the user command for changing a position or an output direction of the plurality of speakers 120 through the user interface.

The microphone 190 may obtain a signal about sound or a voice generated from the outside of the electronic device 100. Specifically, the microphone 190 may obtain vibration according to sound or a voice generated from the outside of the electronic device 100 and convert the obtained vibration to an electric signal.

In particular, the microphone 190 according to the disclosure may obtain a voice signal about the user voice generated by a speech of the user. Further, the obtained signal may be converted to a signal in a digital form and be stored in the memory 140. The microphone 190 may include an Analog to Digital (A/D) converter and may operate in connection with the A/D converter positioned outside the microphone 190.

In particular, in various examples according to the disclosure, the processor 130 may receive a user command for playback of a content, a user command for changing an output direction of the projection portion 110, a user command for changing a position or an output direction of the plurality of speakers 120, or the like through the microphone 190.

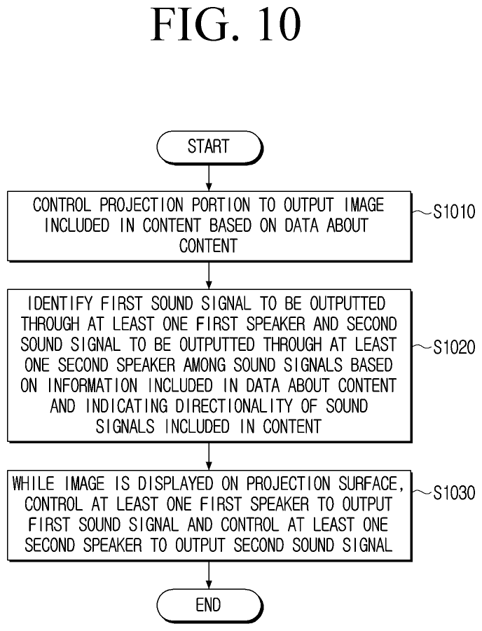

FIG. 10 is a flow chart illustrating a method of controlling an electronic device 100 according to an embodiment.

As shown in FIG. 10, the electronic device 100 may control the projection portion 110 to output an image included in a content based on data about the content (S1010). Here, the data about the content may be data stored in memory 140 or data received from an external device. Also, the operation of outputting the image included in the content may be performed based on a user command for watching the content.

The electronic device 100 may identify a first sound signal to be outputted through the at least one first speaker 120-1 and a second sound signal to be outputted through the at least one second speaker 120-2 among sound signals based on information included in the data about the content and indicating directionality of the sound signals included in the content.

As aforementioned, the ‘first speaker 120-1’ refers to a speaker which may output a sound signal in a direction such that light emitted by the projection portion 110 is directed to the opposite of the projection surface and may be, for example, a ‘lower end speaker’ implementing a sound image corresponding to the lower end area of the projection surface. The second speaker 120-2 refers to a speaker which may output a sound signal corresponding to a sound wave in a direction such that a sound wave is reflected from a ceiling or a wall of a space where the electronic device 100 is disposed and may include at least one of a ‘center speaker’ implementing a sound image corresponding to a center area of the projection surface or an ‘upper end speaker’ implementing a sound image corresponding to the upper end area of the projection surface.

In an example, the electronic device 100 may identify sound signals indicating a left, right, and center direction as sound signals to be outputted through the lower end speaker, identify sound signals indicating an upper end direction as a sound signal to be outputted through the upper end speaker, identify sound signals indicating a left direction as a sound signal to be outputted through a left speaker, identify sound signals indicating a right direction as sound signals to be outputted through the right speaker, and identify sound signals indicating a left, a right, an upper end, and a center direction as sound signals to be outputted through the center speaker.

The electronic device 100 may control at least one first speaker 120-1 to output the first sound signal and control at least one second speaker 120-2 to output the second sound signal while the image is displayed on the projection surface (S1030). Specifically, the electronic device 100 may implement a sound image corresponding to the lower end area of the projection surface by outputting the first sound signal through the first speaker 120-1 and implement a sound image corresponding to the center area or the upper end area of the projection surface by outputting the second sound signal through the second speaker 120-2.

Meanwhile, the method of controlling the electronic device 100 according to the embodiment may be implemented as a program and be provided to the electronic device 100. In particular, the program including the method of controlling the electronic device 100 may be stored in a non-transitory computer readable medium and be provided.

Specifically, in a non-transitory computer readable recording medium storing a program executing a method of controlling an electronic device 100, the method of controlling the electronic device 100 includes controlling a projection portion 110 included in the electronic device 100 to output an image included in a content based on data about the content, identifying a first sound signal to be outputted through the at least one first speaker 120-1 included in the electronic device 100 and a second sound signal to be outputted through the at least one second speaker 120-2 included in the electronic device 100 among sound signals based on information included in data about the content and indicating directionality of the sound signals included in the content, and while the image is displayed on a projection surface, controlling the at least one first speaker 120-1 to output the first sound signal and controlling the at least one second speaker 120-2 to output the second sound signal, wherein the at least one first speaker 120-1 may output a sound signal in a direction toward an opposite of the projection surface on which light emitted by the projection portion 110 is projected, and wherein the at least one second speaker 120-2 may output a sound signal corresponding to a sound wave in at least one direction such that the sound wave is reflected from a ceiling or a wall of a space where the electronic device 100 is disposed.

As above, the method of controlling the electronic device 100 and the computer readable recording medium including the program executing the method of controlling the electronic device 100 are briefly described but it is obvious that it is merely for omitting the overlapped description and various embodiments about the electronic device 100 may be also applied to the method of controlling the electronic device 100 and the computer readable recording medium including the program executing the method of controlling the electronic device 100.

As above, according to various embodiments of the disclosure, the electronic device 100 may match the screen projected by the projection portion 110 to the sound image by using the plurality of speakers 120. Further, the electronic device 100, if a size of the projection screen of the projection portion 110 is changed, may perform sound image positioning per sound channel fitted to the size of the changed projection screen.

Also, the electronic device 100 may minimize an effect of vibration with respect to the optical system included in the projection portion 110 by the plurality of speaker 120 units disposed in the mutual symmetric structure and the interrupter to prevent output sounds from being transmitted to the projection portion 110.

Besides, the electronic device 100 may perform rendering with respect to sound signals to implement a sound image more matching the projection screen, and thus, may provide an immersive sound optimized to the projection screen.

Furthermore, the electronic device 100 may also output a sound signal through the left speaker and the right speaker and thus, widen a sound stage and may enhance a wide stereo effect accordingly.

A machine readable storage medium may be provided in a form of a non-transitory storage medium. Here, the term ‘non-transitory storage medium’ merely means that the storage medium is a tangible device and does not include a signal (e.g. an electromagnetic wave), wherein the term does not distinguish a case where data is stored semi-permanently in the storage medium from a case where data is stored temporarily in the storage medium. For example, the ‘non-transitory storage medium’ may include a buffer where data is temporarily stored.

According to an embodiment, a method according to various examples disclosed in the disclosure may be provided to be included in a computer program product. The computer program product may be traded between a seller and a buyer as goods. The computer program product may be distributed in a form of the machine-readable storage medium (e.g. compact disc read only memory (CD-ROM)) or on-line distributed (e.g. downloaded or uploaded) via an application store (e.g. play store™) or directly between two user devices (e.g. smart phones). In the case of the on-line distribution, at least part of the computer program product (e.g. a downloadable app) may be stored at least temporarily or may be generated temporarily in the machine-readable storage medium such as memory of a server of a manufacturer, a server of an application store, or a relay server.

As aforementioned, each of the components (e.g. a module or a program) according to the various embodiments of the disclosure as above may be configured as a single item or a plurality of items, wherein partial subcomponents of the aforementioned relevant subcomponents may be omitted or another subcomponent may be further included in various embodiments. Mostly or additionally, some components (e.g. a module or a program) may be integrated into one item and may identically or similarly perform a function implemented by each of the relevant components before the integration.

According to various embodiments, operations performed by a module, a program, or another component may be executed sequentially, in parallel, repetitively, or heuristically, at least part of the operations may be executed in different orders or be omitted, or another operation may be added.

Meanwhile, the term “part” or “module” used in the disclosure may include a unit configured of hardware, software, or firmware and may be interchangeably used with the term, for example, logic, a logic block, a part, a circuit, or the like. The term “part” or “module” may be an integrally configured component or a minimum unit or its part performing one or more functions. For example, the module is configured as an application-specific integrated circuit (ASIC).

The various examples of the disclosure may be implemented as software including instructions stored in the machine-readable storage media, which can be read by the machine (e.g. a computer). The machine refers to a device which calls instructions stored in the storage medium and is operable according to the called instructions, wherein it may include an electronic device (e.g. an electronic device 100) according to the disclosed embodiments.

If the instructions are executed by a processor, the processor may perform a function corresponding to the instructions directly or by using other components under control of the processor. The instructions may include a code generated or executed by a compiler or an interpreter.

As above, preferable examples of the present disclosure are shown and described. However, it is to be understood that the disclosure is not limited to the aforementioned specific examples, and various modifications may be implemented by those skilled in the art without deviating from the gist of the disclosure claimed in the scope of claims. These modifications should not be independently understood from the technical spirit or prospect of the disclosure.

What is claimed is:

1. An electronic device comprising:
a projection portion;
a memory;
at least one first speaker to output a first sound signal along a direction opposite a projection surface on which light emitted by the projection portion is projected;
at least one second speaker to output a second sound signal corresponding to a sound wave along at least one direction such that the sound wave is reflected from a ceiling or a wall of a space where the electronic device is disposed; and
at least one processor configured to:
control the projection portion to output an image included in a content based on data about the content;
identify whether at least one of the first sound signal is to be outputted through the at least one first speaker and the second sound signal is to be outputted through the at least one second speaker among sound signals based on information included in the data about the content and directionality indicated in association with the sound signals; and
while the image is displayed on the projection surface, control the at least one first speaker to output the first sound signal and control the at least one second speaker to output the second sound signal.

2. The electronic device of claim 1, wherein the at least one first speaker is a lower end speaker implementing a sound image corresponding to a lower end area of the projection surface, and
wherein the at least one second speaker includes at least one of a center speaker implementing a sound image corresponding to a center area of the projection surface or an upper end speaker implementing a sound image corresponding to an upper end area of the projection surface.

3. The electronic device of claim 2, further comprising:
a plurality of third speakers including a left speaker implementing a sound image corresponding to a left area of the projection surface and a right speaker implementing a sound image corresponding to a right area of the projection surface.

4. The electronic device of claim 3, wherein at least one of the at least one first speaker or the at least one second speaker includes a plurality of holes or a waveguide structure for adjusting a direction of a sound wave corresponding to the first sound signal or the second sound signal, respectively.

5. The electronic device of claim 1, wherein the at least one first speaker includes at least one of a plurality of speaker units disposed in a mutual symmetric structure for offsetting vibration incurred from the first sound signal outputted by the at least one first speaker and an interrupter for preventing sound outputted by the at least one first speaker from being transmitted to the projection portion.

6. The electronic device of claim 1, further comprising:
a driving portion; and
a sensor,
wherein the at least one processor is configured to:
obtain information about a distance between the projection portion and the projection surface through the sensor; and
control the driving portion to change a position or an output direction of at least one of the at least one first speaker or the at least one second speaker based on the information about the distance.

7. The electronic device of claim 6, wherein the at least one processor is configured to:
adjust a parameter related to at least one sound image of the first sound signal or the second sound signal based on the information about the distance; and
control the at least one first speaker to output the first sound signal and control the at least one second speaker to output the second sound signal based on the adjusted parameter.

8. A method of controlling an electronic device, comprising:
controlling a projection portion included in the electronic device to output an image included in a content based on data about the content;
identifying whether at least one of the first sound signal is to be outputted through at least one first speaker included in the electronic device and the second sound signal is to be outputted through at least one second speaker included in the electronic device among sound signals based on information included in the data about the content and directionality indicated in association with the sound signals; and
while the image is displayed on a projection surface, controlling the at least one first speaker to output the first sound signal and controlling the at least one second speaker to output the second sound signal,
wherein the at least one first speaker outputs the first sound signal along a direction opposite the projection surface on which light emitted by the projection portion is projected; and
wherein the at least one second speaker outputs the second sound signal corresponding to a sound wave in at least one direction such that the sound wave is reflected from a ceiling or a wall of a space where the electronic device is disposed.

9. The method of claim 8, wherein the at least one first speaker is a lower end speaker implementing a sound image corresponding to a lower end area of the projection surface, and
wherein the at least one second speaker includes at least one of a center speaker implementing a sound image corresponding to a center area of the projection surface or an upper end speaker implementing a sound image corresponding to an upper end area of the projection surface.

10. The method of claim 9, further comprising:
a plurality of third speakers including a left speaker implementing a sound image corresponding to a left area of the projection surface and a right speaker implementing a sound image corresponding to a right area of the projection surface.

11. The method of claim 10, wherein at least one of the at least one first speaker or the at least one second speaker includes a plurality of holes or a waveguide structure for adjusting a direction of a sound wave corresponding to a sound signal.

12. The method of claim 8, wherein the at least one first speaker includes at least one of a plurality of speaker units disposed in a mutual symmetric structure for offsetting vibration incurred from the sound signal outputted by the at least one first speaker and an interrupter for preventing sound outputted by the at least one first speaker from being transmitted to the projection portion.

13. The method of claim 8, wherein the method of controlling the electronic device includes:
obtaining information about a distance between the projection portion and the projection surface; and
controlling a driving portion included in the electronic device to change a position or an output direction of at least one of the at least one first speaker or the at least one second speaker based on the information about the distance.

14. The method of claim 13, wherein the method of controlling the electronic device further includes:
adjusting a parameter related to at least one sound image of the first sound signal or the second sound signal based on the information about the distance; and
controlling the at least one first speaker to output the first sound signal and controlling the at least one second speaker to output the second sound signal based on the adjusted parameter.

15. A non-transitory computer readable recording medium including a program executing a method of controlling an electronic device, wherein the method of controlling the electronic device includes:
controlling a projection portion included in the electronic device to output an image included in a content based on data about the content;
identifying whether at least one of the first sound signal is to be outputted through at least one first speaker included in the electronic device and the second sound signal is to be outputted through at least one second speaker included in the electronic device among sound signals based on information included in data about the content and directionality indicated in association with the sound signals; and
while the image is displayed on a projection surface, controlling the at least one first speaker to output the first sound signal and controlling the at least one second speaker to output the second sound signal,
wherein the at least one first speaker outputs the first sound signal along a direction opposite the projection surface on which light emitted by the projection portion is projected; and
wherein the at least one second speaker outputs the second sound signal corresponding to a sound wave along at least one direction such that the sound wave is reflected from a ceiling or a wall of a space where the electronic device is disposed.
